(19) United States
(12) Patent Application Publication
(10) Pub. No.: US 2007/0288403 A1
(43) Pub. Date: Dec. 13, 2007

(54) Risk management in energy services

(75) Inventors: Dharmashankar Subramanian, Elmsford, NY (US); Anoop K. Mathur, Shoreview, MN (US); Saad J. Bedros, West St. Paul, MN (US)

Correspondence Address: Kris Fredrick;Honeywell International Inc., 101 Columbia Rd., P.O. Box 2245, Morristown, NJ, 07962, US

(73) Assignee: Honeywell International Inc.

(21) Appl. No.: 11/452,488

(22) Filed: Jun. 13, 2006

(51) Int. Cl. G06F 17/00

(52) U.S. Cl. 705/412

(57) ABSTRACT

A computer implemented method for risk management in energy services. A plurality of cost components and a set of interrelationships among the plurality of cost components can be compiled. Thereafter, the plurality of cost components and set interrelationships among the plurality of cost components can be provided to a large scale linear module. The cost components and interrelationships among the cost components can be processed utilizing the large scale linear module in order to provide data indicative of one or more optimal decisions for establishing a baseline for contracting dialogues between a consumer and a utility company in favor of the consumer.

### TECHNICAL FIELD

Embodiments are generally related to data-processing devices and techniques. Embodiments are also related to tools for enhancing negotiations between consumers and companies. Embodiments are additionally related to the optimization of the purchase of power from a utility.

### BACKGROUND

Currently, there do not exist efficient tools to assist electric utility customers in negotiating superior energy contracts with electric utility companies. There is a void in efficient tools that help utility customers negotiate superior energy contracts with utility companies. Utility customers have a wealth of historical data about their energy requirements and about real time prices of energy. Although this data could help them in determining optimum contract terms, there are no tools to assist electric utility customers in using such data to choose a rate structure and to specify a Contract Base Load (CBL) so that the customers can intelligently enter into power supply contracts with their electric utilities.

Moreover, on-site generation of electrical power is an option to many customers. However, complex issues face these customers in determining whether on-site generation of electrical power is a viable alternative to the purchase of power from electric utilities. For example, customers must determine whether on-site generation equipment should be acquired and how much to invest in the acquisition of on-site generation equipment. Moreover, the purchase of such equipment raises additional questions affecting these investment decisions such as determining when such on-site generation equipment should be engaged, and the extent to which the on-site generation equipment should be engaged. It is also necessary to determine the cost of running and maintaining the on-site generation equipment.

These decisions need to be made so as to minimize the total annual cost of electrical power to the customer. The total annual cost of electrical power is based on (a) the pricing logic of the rate structure (that typically includes an energy charge and a demand charge) relative to the Contract Base Load, (b) the cost of purchasing energy at the real time price, (c) any capital investment that is required for on-site generation equipment, and (d) the costs of operating and maintaining on-site generation equipment.

As can be seen, these decisions present electric utility customers with a complex commercial problem. Unfortunately, current tools that are intended to help these customers deal with this complex problem are too simple to be of significant use. Indeed, many customers would rather rely on their instincts and experience in making these decisions.

The Supply Side Problem (SSP) has been described as a deterministic optimization problem. For example, U.S. Patent Application Publication No. 20040117236, entitled “Automated Optimization Tool for Electric Utility Supply Services,” by Dharmashankar Subramanian, et al. addresses a more realistic version of the SSP by identifying sources of uncertainty that make it a stochastic optimization problem. U.S. Patent Application Publication No. 20040117236 also describes a computational framework for tackling the stochastic optimization by integrating the individual merits of mathematical programming, Monte-Carlo simulation, and heuristic search techniques such as Scatter Search, Tabu Search and Genetic Algorithms. Note that U.S. Patent Application Publication No. 20040117236 is incorporated herein by reference.

As noted in U.S. Patent Application Publication No. 20040117236, the input into the SSP includes an hourly forecast of the expected energy requirements and the expected real time price of electricity. Both these inputs are subject to uncertainty and are therefore interval estimates, which are quantified respectively by probability distributions as opposed to point estimates. The deterministic SSP seeks the optimal choice of the rate structure and the specification of a customer base load (CBL) that goes with the rate structure, for the deterministic objective of minimizing the annual cost, as noted in U.S. Patent Application Publication No. 20040117236.

Clearly, any choice of rate structure along with a customer base load will imply a distribution of the resulting annual cost due to the uncertainties noted above. In the face of such uncertainty, a stochastic objective becomes more relevant. Such a stochastic objective needs to target the interval aspect of the annual cost distribution, as opposed to the point aspect (as in say, the central tendency, or expected value, of the annual cost distribution). Example stochastic objectives include minimizing the variance of the resulting cost distribution, or maximizing the Probability of Cost being less than, for example, $53.5 million.

Based on the foregoing, it is believed that there exists a need for a practical framework for stochastic optimization that leverages the state-of-the-art expertise that has been achieved over the years in deterministic optimization technology. Such a framework should be provide in the context of a method, system and/or program product and should also overcome the uncertainty that often arises in SSP, particularly with respect to problem-input data, when viewed in the context of the deterministic mathematical programming formulations described, for example, in U.S. Patent Application Publication No. 20040117236.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved data-processing techniques and devices.

It is yet another aspect of the present invention to provide for improved tools for enhancing negotiations between consumers and companies.

It is a further aspect of the present invention to provide for a method, system and program product for optimizing the purchase of power from a utility.

The aforementioned aspects of the invention and other objectives and advantages can now be achieved as described herein. A computer implemented method for risk management in energy services is disclosed. A plurality of cost components and a set of interrelationships among the plurality of cost components can be compiled. Thereafter, the plurality of cost components and set interrelationships among the plurality of cost components can be provided to a large scale linear module. The cost components and interrelationships among the cost components can be processed utilizing the large scale linear module in order to provide data indicative of one or more optimal decisions for establishing a baseline for contracting dialogues between a consumer and a utility company in favor of the consumer.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a block diagram of a data-processing apparatus, which can be adapted for use in implementing a preferred embodiment;

FIG. 2 illustrates a block diagram of an exemplary computational system that may be used to search for input values to an optimization procedure utilized in accordance with a preferred embodiment; and

FIG. 3 illustrates a high-level flow chart depicting a process for risk management in energy services, in accordance with a preferred embodiment.

### DETAILED DESCRIPTION

The particular values and configurations discussed in these non-limiting examples can be varied and are cited merely to illustrate at least one embodiment and are not intended to limit the scope of the invention.

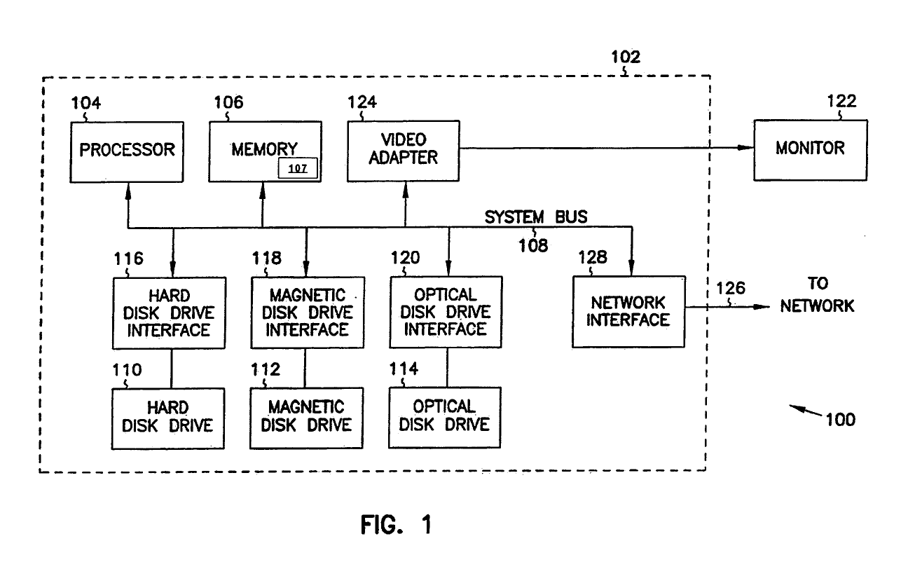

FIG. 1 illustrates a block diagram of a data-processing apparatus 100, which can be utilized to implement a preferred embodiment. Data-processing apparatus 100 (e.g., a computer) can be utilized to implement optimization formulation procedures for consumer decision making in consumer and utility contractual negotiations as described in greater detail herein. Data-processing apparatus 100 can be configured to include a general purpose computing device, such as a computer 102. The computer 102 includes a processing unit 104, a memory 106, and a system bus 108 that operatively couples the various system components to the processing unit 104. One or more processing units 104 operate as either a single central processing unit (CPU) or a parallel processing environment.

The data-processing apparatus 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium. A monitor 122 is connected to the system bus 108 through an adapter 124 or other interface. Additionally, the data-processing apparatus 100 can include other peripheral output devices (not shown), such as speakers and printers.

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the data-processing apparatus 100. Note that such computer-readable instructions, data structures, program modules, and other data can be implemented as a module 107.

Note that the embodiments disclosed herein can be implemented in the context of a host operating system and one or more module(s) 107. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 100, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the embodiments.

A number of program modules can be stored or encoded in a machine readable medium such as the hard disk drive 110, the, magnetic disk drive 114, the optical disc drive 114, ROM, RAM, etc or an electrical signal such as an electronic data stream received through a communications channel. These program modules can include an operating system, one or more application programs, other program modules, and program data.

The data-processing apparatus 100 can operate in a networked environment using logical connections to one or more remote computers (not shown). These logical connections are implemented using a communication device coupled to or integral with the data-processing apparatus 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the data-processing apparatus 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

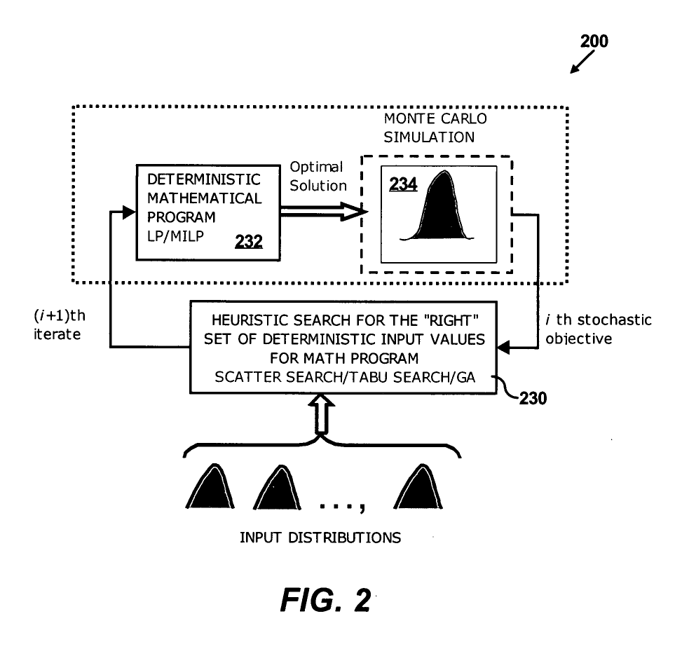

FIG. 2 illustrates a block diagram of an exemplary computational system 200 that may be used to search for input values to an optimization procedure utilized in accordance with a preferred embodiment. System 200 depicted in FIG. 2 generally a heuristic search procedure module 230 (such as Scatter Search, Tabu Search, or Genetic Algorithm) that can be utilized to search for the “right” set of deterministic input values (for the uncertain parameters) in a deterministic math program or module 232. The deterministic math program or module 232 implements one of the objective functions set out above and is an optimizer that solves for the optimal solution, which is fed into a Monte Carlo simulation module 234 for numerically calculating the value of the stochastic objective corresponding to the above deterministic optimal solution. The value of the stochastic objective can be communicated to the heuristic search procedure module 230, which then proceeds to determine the next iteration (or candidate).

With respect to the heuristic search procedure module 230, the calculation of the stochastic objective for a given iteration is like a black-box calculation. The space of possible values that the input stochastic parameters can take is assumed to be bounded by the intervals over which their respective probability distributions are defined in the input. In other words, the heuristic search procedure module 230 searches for the “right” point inside a bounded hyper-rectangle (whose dimensions are equal to the number of uncertain inputs). The heuristic search procedure module 230 can also be made to search over a space having fewer dimensions, by grouping together uncertainties according to the same resolution at which the Contract Base Load solution to the objective function is being sought. In other words, in the search over the smaller space, all the uncertain parameters in a given group will have their k-th percentile value (say) as the deterministic value in any given iteration.

Such a procedure combines the relative merits of the mathematical programming and heuristic search algorithms. A neural network can also be used in the heuristic search procedure module 230 to build the stochastic objective landscape over the space of possible values that the input stochastic parameters can assume. Such a landscape can assist the heuristic search procedure in determining its next iteration. Such a framework could reveal that it may be better to use worst case values in summer peak periods and most likely values in, say, other periods, because variations in hot summer periods may be the biggest contributor to variance.

The embodiments can be implemented in the context of a practical framework for stochastic optimization that leverages the state-of-the-art expertise that has been achieved over the years in deterministic optimization technology. The uncertainty in SSP arises in the problem-input data, when viewed in the context of deterministic mathematical programming formulations. Different combinations of the individual realizations of the various stochastic input parameters can lead to different instances of the deterministic mathematical programming formulation. In turn, these different instances can lead to different deterministic optimal solutions, which in turn, when simulated in the face of uncertainties, can lead to different annual cost distributions, or in other words, different values for the stochastic objective of interest.

One way to retain the merits of the deterministic optimization formulation would be to search for the “right” set of input values to use as deterministic input for the deterministic math program. This is so that the resulting deterministic formulation instance yields an optimal solution, which leads to a desirable stochastic objective, when simulated in the face of uncertainty.

A deterministic optimizer, such as for example, the deterministic module 232 can be utilized to solve for the optimal solution, which can be then fed into the Monte Carlo simulation module 234 for numerically calculating the value of the stochastic objective corresponding to the above deterministic optimal solution. The Monte Carlo simulation module 234 can be utilized to characterize the total cost as a distribution, and this distribution captures the variability of the cost faced by the customer.

One way to retain the merits of the deterministic optimization formulation can be to search for the “right” set of input values to use as the deterministic input for the deterministic math program. The resulting deterministic formulation instance yields an optimal solution, which leads to a desirable stochastic objective when simulated in the face of uncertainty.

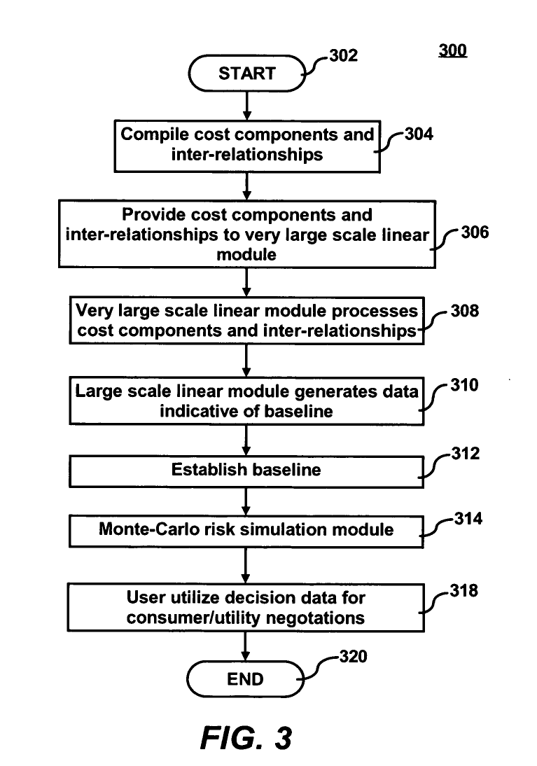

FIG. 3 illustrates a high-level flow chart depicting a process 300 for risk management in energy services, in accordance with a preferred embodiment. The process 300 depicted in FIG. 3 can be provided in the context of a module or group of modules, such as, for example, module 107 depicted in FIG. 1. As indicated at block 302, the process can be initiated. Thereafter, as depicted at block 304, one or more cost components and one or more inter-relationships among the cost components can be compiled. Next, as described at block 306, the cost components and interrelationships can be provided to a very large scale linear module. Note that such cost components can include data such as, for example, historical data of energy requirements, real time prices of energy for use in forecasting techniques, and other information such as a set of rate structures associated with electric energy.

Thereafter, as indicated at block 308, the large scale linear module can process the cost components and inter-relationships in order to generate data indicative of one or more optimal decisions as depicted at block 310 for establishing a baseline as indicated at block 312 for contracting dialogues between a consumer and a utility company in the favor of the consumer. An optional Monte Carlo risk simulation module such as module 234 depicted in FIG. 2 can then be utilized to analyze the optimal decision data in order to enhance the baseline for consumer and utility contractual negotiations as depicted at block 318. Such a baseline can be implemented as, for example, customer base load or “firm power”. The process can then be terminated as indicated at block 320.

The embodiments generally possess two key aspects. First, the embodiments can cast the above commercial decision-making problem into a creative mathematical programming framework as evidence by the method depicted in FIG. 3. The key nugget in this aspect of the embodiments is the optimization formulation provided by the process depicted in FIG. 3, which mathematically models all the cost components and their complex interrelationships into a very large scale linear program or module. Creative math modeling makes this possible, despite any nonlinearities present in the logic of the rate structures. The second aspect involves the computer implementation of a large scale linear program, which upon solution provides optimal decisions that the utility consumer can implement. A particular embodiment of this invention pertains to the Electric Utility Supply. A third aspect involves Monte-Carlo risk analysis added on top of the mathematical program as indicated at block 314 in FIG. 3 and block 234 in FIG. 2.

Note additionally that an additional feature of the embodiments can be implemented based on an objection function and or a constraint as indicated generally as follows:

a) For a user-input level of risk (input by the user as, the probability, p(M), such that the total annual cost of the user is less than or equal to a user-defined constant, say, M), the method will give the least-cost (optimal) rate structure and the associated CBL, along with on-site generation utilization (if applicable).

b) Conversely, if the user desires to minimize the risk measure, that minimize the probability, p(M), which is the probability that the annual cost is greater than or equal to a user-defined constant, M, then the method will minimize this measure.

In other words, the method can accept the risk-measure both as a constraint (case (a)) and as an objective function (case (b)).

The process and system described herein can be used by utility consumers, energy managers, and energy aggregators for establishing a baseline for their contracting dialogue with the utility companies. Consumers have access to historical data of energy utilization patterns and real time price of electric energy that can be used in forecasting techniques. They also have the set of rate structures that their utility company offers them. They can use all this data with the mathematical formulation contained in the invention to create a corresponding instance of a large scale linear program, to answer their decision-making questions. These answers can be used to start the contracting dialogue with the utility firms to the consumer's advantage.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method for risk management in energy services, comprising:
compiling a plurality of cost components and a set of interrelationships among said plurality of cost components;
providing said plurality of cost components and set interrelationships among said plurality of cost components to a large scale linear module; and
processing said plurality of cost components and said set of interrelationships among said plurality of cost components utilizing said large scale linear module in order to provide data indicative of at least one optimal decision for establishing a baseline for contracting dialogues between a consumer and a utility company in the favor of said consumer.

2. The method of claim 1 further comprising:
analyzing said data indicative of said at least one optimal decision utilizing a Monte Carlo risk simulation module in order to enhance said baseline for contracting dialogues between a consumer and a utility company in the favor of said consumer.

3. The method of claim 1 wherein said plurality of cost components comprises historical data of energy requirements.

4. The method of claim 1 wherein said plurality of cost components comprises real times prices of energy for use in energy forecasting.

5. The method of claim 1 wherein said plurality of cost components comprises a set of rate structures associated with electric energy.

6. The method of claim 1 wherein said baseline comprises a customer base load.

7. The method of claim 1 further comprising utilizing said base line for negotiating a supply contract between said consumer and said utility company.

8. The method of claim 1 wherein processing said plurality of cost components and said set of interrelationships among said plurality of cost components utilizing said large scale linear module in order to provide data indicative of at least one optimal decision for establishing a baseline for contracting dialogues between a consumer and a utility company in the favor of said consumer, further comprises:
accepting a risk measure as a constraint or and as an objective function.

9. A system for risk management in energy services, comprising:
a data-processing apparatus;
a module executed by said data-processing apparatus, said module and said data-processing apparatus being operable in combination with one another to:
compile a plurality of cost components and a set of interrelationships among said plurality of cost components;
provide said plurality of cost components and set interrelationships among said plurality of cost components to a large scale linear module; and
process said plurality of cost components and said set of interrelationships among said plurality of cost components utilizing said large scale linear module in order to provide data indicative of at least one optimal decision for establishing a baseline for contracting dialogues between a consumer and a utility company in the favor of said consumer.

10. The system of claim 9 wherein said module and said data-processing apparatus are operable in combination with one another to:
analyze said data indicative of said at least one optimal decision utilizing a Monte Carlo risk simulation module in order to enhance said baseline for contracting dialogues between a consumer and a utility company in the favor of said consumer.

11. The system of claim 9 wherein said plurality of cost components comprises historical data of energy requirements.

12. The system of claim 9 wherein said plurality of cost components comprises real times prices of energy for use in energy forecasting.

13. The system of claim 9 wherein said plurality of cost components comprises a set of rate structures associated with electric energy.

14. The system of claim 9 wherein said baseline comprises a customer base load.

15. The system of claim 9 said module and said data-processing apparatus are operable in combination with one another to:
permit said consumer to utilize said base line for negotiating a supply contract between said consumer and said utility company.

16. A program product residing in a computer for providing risk management in energy services, comprising:
instruction media residing in a computer for compiling a plurality of cost components and a set of interrelationships among said plurality of cost components;
instruction media residing in a computer for providing said plurality of cost components and set interrelationships among said plurality of cost components to a large scale linear module; and
instruction media residing in a computer for processing said plurality of cost components and said set of interrelationships among said plurality of cost components utilizing said large scale linear module in order to provide data indicative of at least one optimal decision for establishing a baseline for contracting dialogues between a consumer and a utility company in the favor of said consumer.

17. The program product of claim 16 further comprising:
instruction media residing in a computer for analyzing said data indicative of said at least one optimal decision utilizing a Monte Carlo risk simulation module in order to enhance said baseline for contracting dialogues between a consumer and a utility company in the favor of said consumer.

18. The program product of claim 16 wherein said plurality of cost components comprises historical data of energy requirements.

19. The program product of claim 16 wherein said plurality of cost components comprises real times prices of energy for use in energy forecasting.

20. The program product of claim 16 wherein said plurality of cost components comprises a set of rate structures associated with electric energy.
